(19) United States
(12) Patent Application Publication
(10) Pub. No.: US 2010/0228441 A1
(43) Pub. Date: Sep. 9, 2010

(54) ELECTRIC POWER STEERING SYSTEM DESIGNED TO GENERATE TORQUE FOR ASSISTING DRIVER'S TURNING EFFORT

(75) Inventors: Daiji Watanabe, Nagoya (JP); Takehito Fujii, Anjo-shi (JP); Tomoyuki Hori, Handa-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/720,245

(22) Filed: Mar. 9, 2010

(30) Foreign Application Priority Data
Mar. 9, 2009 (JP) 2009-055617

(51) Int. Cl. G06F 19/00

(52) U.S. Cl. 701/41

(57) ABSTRACT

In a steering system, a generator generates a first commanded value for assist torque, and a converter converts a second commanded value for the assist torque to a commanded current value. A current controller controls a drive current for driving a motor for generating the assist torque. A characteristic limiter is functionally interposed between a commanded-value generator and a converter, and limits, to a preset characteristic range, a characteristic of a functional downstream of the converter in the steering system. The functional downstream of the converter in the steering system includes a steering mechanism including the motor. The commanded-value generator inputs, to the characteristic limiter, the first commanded value. The characteristic limiter determines the second commanded current value for the assist torque based on the characteristic of the functional downstream and the first commanded value.

### CROSS REFERENCE TO RELATED APPLICATIONS

This application is based on Japanese Patent Application 2009-035617 filed on Mar. 9, 2009. This application claims the benefit of priority from the Japanese Patent Application, so that the descriptions of which are all incorporated herein by reference.

### FIELD OF THE INVENTION

The present invention relates to electric power steering systems, in other words, electric power assisted steering systems, capable of generating torque to assist the driver's turning effort. More particularly, the present invention relates to such electric steering systems designed to reduce the number of human-hours required to tune them.

### BACKGROUND OF THE INVENTION

Some types of these electric power steering systems include: a torque sensor and a steering mechanism including a motor for generating torque to assist the driver's turning effort; this torque will be referred to as “assist torque” hereinafter. They also include a controller for determining a commanded value for the assist torque, a converter for converting the commanded value to a commanded current value, and a current controller for controlling a drive current to be applied to the motor such that the drive current is matched with the commanded current value.

In order to determine the commanded value for the assist torque, many control constants need be tuned.

For example, Japanese Patent Application Publication No. 2002-249063 discloses an example of a method of tuning the control constants. In the disclosed method, phase compensation is applied to torque measured by the torque sensor and fed back therefrom, and a basic assist torque is determined according to the phase-compensated torque and a vehicle speed. Thereafter, inertial compensation, damping control, and steering-wheel returning control for the basic assist torque are carried out so that the commanded value for the assist torque is finally determined.

As described above, many control and compensation processes are required to determine the commanded value for the assist torque, and they interfere with each other; these control and compensation processes will be referred to collectively as correction processes. For these reasons, there are a large number of human-hours for tuning control constants required to carry out these compensation processes.

In addition, the control constants are required to be adjusted according to: change in control parameters in the current controller, and change in the steering mechanism, such as change in the motor, change of gears of the steering mechanism, and change in grease in the steering mechanism.

For this reason, electric power steering systems designed to be installed in one types of motor vehicles are required to be tuned with a large number of human-hours according to: model changes in the one types of motor vehicles, and development thereof into other types of motor vehicles.

In order to reduce a number of human-hours required to tune an electric power steering system, adaptive equipment has been proposed by Japanese Patent Application Publication No. 2006-175939 to make more efficient the tuning procedures.

The proposed adaptive equipment determines whether an operator's inputted control constant for changing at least one of the existing control constants of an electric power steering system is enabled or disabled. When the operator's inputted control constant for changing at least one of the existing control constants of the electric power steering system is disabled, the proposed adaptive equipment gives a warning to an operator.

### SUMMARY OF THE INVENTION

The inventors have discovered that there are some problems in the conventional techniques set forth above.

Specifically, even if the adaptive equipment disclosed in the Publication No. 2006-175939 is used, an operator only knows whether an inputted control parameter for changing at least one of the existing control constants of the electric power steering system is enabled or disabled. Thus, an operator has to carry out works to tune many effective control constants in order to give drivers comfortable steering feeling. For this reason, the number of human-hours required to tune the effective control constants may not be sufficiently reduced.

In view of the circumstances set force above, the present invention seeks to provide electric power steering systems installed in corresponding vehicles and each designed to solve at least one of the problems set forth above.

Specifically, the present invention aims at providing such electric power steering systems configured to facilitate their designs with small influence of change in at least one of their control constants.

According to one aspect of the present invention, there is provided an electric power steering system installed in a vehicle and operative to generate, by a steering mechanism including a motor, assist torque for assisting turning effort of the steering wheel by a driver. The electric power steering system includes a commanded-value generator that generates a first commanded value for the assist torque, and a converter that converts a second commanded value for the assist torque to a commanded current value. The electric power steering system includes a current controller that controls a drive current for driving the motor so as to cause the motor to generate a value of the assist torque. The value of the assist torque corresponds to the commanded current value. The electric power steering system includes a characteristic limiter that is functionally interposed between the commanded-value generator and the converter and that limits, to a preset characteristic range, a characteristic of a functional downstream of the converter in the electric power steering system. The functional downstream of the converter in the electric power steering system includes the steering mechanism. The commanded-value generator is configured to input, to the characteristic limiter, the first commanded value for the assist torque generated thereby. The characteristic limiter is configured to determine the second commanded current value for the assist torque based on the characteristic of the functional downstream of the converter in the electric power steering system and the first commanded value for the assist torque.

In the one aspect of the present invention, the characteristic limiter is interposed between the commanded-value generator and the converter. The characteristic limiter is configured to limit, to the preset characteristic range, the characteristic of the functional downstream of the converter in the electric power steering system. The commanded-value generator is configured to input, to the characteristic limiter, the first commanded value for the assist torque generated thereby.

This configuration allows the commanded-value generator to be designed on condition that the characteristic of the functional downstream of the converter in the electric power steering system is limited to the preset characteristic range. Thus, it is possible to easily design the commanded-value generator in comparison to conventional electric power steering systems.

In addition, this configuration makes it unnecessary to redesign the commanded-value generator even if at least one control parameter required for the current controller to control the drive current for driving the motor is changed, or at least part of the steering mechanism of the electric power steering system is changed. Thus, it is possible to reduce the number of human-hours required to tune at least one control constant required for the current controller to control the drive current for driving the motor.

### BRIEF DESCRIPTION OF THE DRAWINGS

Other objects and aspects of the invention will become apparent from the following description of embodiments with reference to the accompanying drawings in which:

FIG. 1 is a view schematically illustrating an example of the overall structure of an electric power steering system according to an embodiment of the present invention;

FIG. 2 is a block diagram schematically illustrating an example of the overall functional structure of the electric power steering system illustrated in FIG. 1;

FIG. 3 is a block diagram schematically illustrating an example of the specific structure of an internal hiding controller illustrated in FIG. 1;

FIG. 4 is a Bode diagram of an example of the characteristics of a real system when torque inputted by the driver's turning of a steering wheel illustrated in FIG. 1 is inputted to the real system so that a torsion torque is outputted therefrom according to the embodiment;

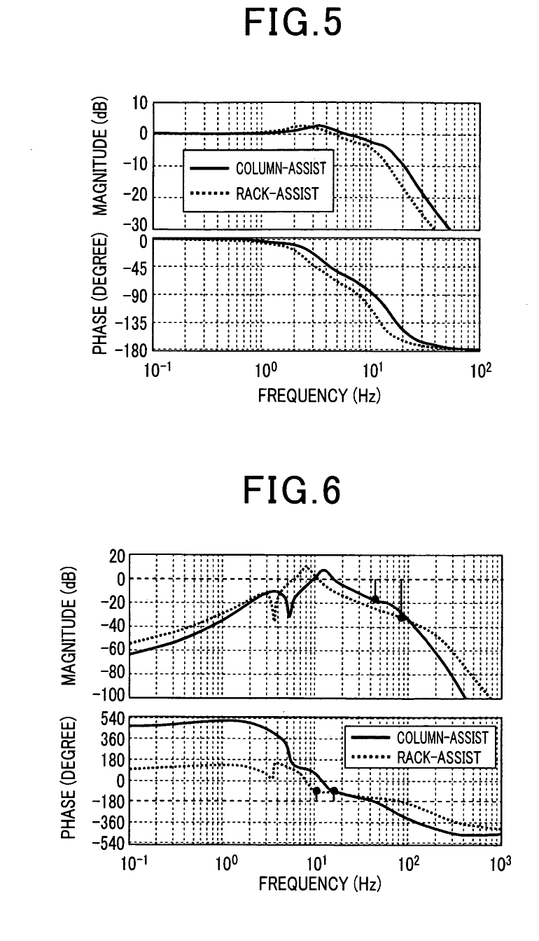

FIG. 3 is a Bode diagram of an example of the characteristics of the real system in which the internal hiding controller is provided when the torque inputted by the driver's turning of the steering wheel is inputted to the real system so that the torsion torque is outputted therefrom;

FIG. 6 is a Bode diagram of an open-loop frequency response of a controller of the internal hiding controller;

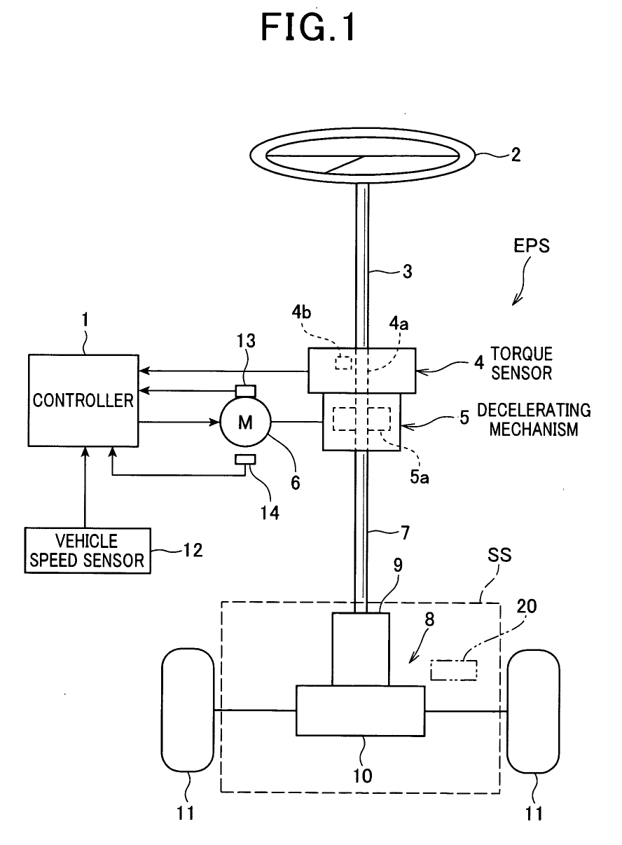

FIG. 7 is a block diagram schematically illustrating an example of the specific structure of an assist controller illustrated in FIG. 1; and

FIG. 8 is a view schematically illustrating an example of the model of the electric power steering system illustrated in FIG. 1.

### DETAILED DESCRIPTION OF EMBODIMENTS OF THE INVENTION

An embodiment of the present invention will be described hereinafter with reference to the accompanying drawings. In the drawings, identical reference characters are utilized to identify identical corresponding components.

An electric power steering system EPS according to the embodiment of the present invention is installed in, for example, a four-wheel motor vehicle. The electric power steering system EPS includes a controller 1, a torque sensor 4, a decelerating mechanism 5, a motor 6, a rotational angle sensor 13, and a motor-current sensing circuit 14.

The torque sensor 4 is made up of a torsion bar 4a and a sensing element 4b.

The torsion bar 4a is, for example, a long spring steel rod. One end of the torsion bar 4a is coupled to a steering shaft (steering column) 3 of the motor vehicle to which a steering wheel 2 of the motor vehicle is coupled. The steering shaft 3 is configured to be rotatable together with the steering wheel 2. The other end of the torsion bar 4a is coupled to one end of an intermediate shaft 7.

The decelerating mechanism 5 is made up of a gear mechanism 5a. For example, the gear mechanism 5a, is provided with a wheel gear and a worm gear. The wheel gear is so mounted on the steering shaft 7 as to be rotatable therewith. The worm gear is engaged with the wheel gear, and fixedly coupled to an output shaft of the motor 6.

The controller 1 is communicably connected to the torque sensor 4, the motor 6, the rotational angle sensor 13, the motor-current sensing circuit 14, and a vehicle speed sensor 12; this vehicle speed sensor 12 is installed in the motor vehicle according to the embodiment. The motor 6 is operative to generate assist torque for assisting the driver's turning effort of the steering wheel 2.

Rotation of the steering shaft 3 relative to the intermediate shaft 7 causes the torsion bar 4a to be twisted against the elastic force of the torsion bar 4a. The sensing element 4b measures the torsion (twist) of the torsion bar 4a as torsion torque Ts. Specifically, each time the torsion bar 4a is twisted, the sensing element 4b sends, to the controller 1, a signal indicative of the corresponding torsion torque Ts.

The gear mechanism 5a of the decelerating mechanism 5 is designed to transfer rotation of the output shaft of the motor 6 to the intermediate shaft 7 (steering shaft 3) while reducing the rotational speed, in other words, increasing torque by the rotation of the output shaft of the motor 6.

The above descriptions make clear that the electric power steering system EPS is designed as a column-assist (shaft-assist) electric power steering system.

The motor 6 is made up of, for example, an armature and a field member. When a drive current for the motor 6 is supplied to flow through the armature so that the armature generates a magnetic field, the generated magnetic field of the armature and a magnetic field generated by the field member rotate any one of the armature and the field member relative to the other thereof to thereby rotate the output shaft of the motor 6.

The motor vehicle is installed with a steering system SS. The steering system SS is made up of a gear box 8, tie rods (not shown), steering knuckles (not shown), and so on.

The gear box 8 consists of a pinion shaft 9 and a rack 10 engaged with each other. The rack 10 is coupled at their both ends to the tie rods coupled to knuckle arms (steering arms) serving as an integral part of the steering knuckles. The steering knuckles are coupled to, for example, front wheels 11 of the motor vehicle.

The other end of the intermediate shaft 7 is coupled to the pinion shaft 9. Rotation of the intermediate shaft 7 rotates the pinion shaft 9. Rotation of the pinion shaft 9 is converted by the gear box 8 into straight-line motion of the rack 10 and the tie rods. Straight-line motion of the tie rods pivot the knuckle arms to thereby pivot the front wheels 11 by angles corresponding to the displacement of the rack 10.

The vehicle speed sensor 12 is operative to, for example, continuously measure the actual vehicle speed V of the motor vehicle, and output a signal indicative of the actual vehicle speed V to the controller 1. The rotational angle sensor 13 is operative to, for example, continuously measure the actual rotational angle θc of the motor 6 relative to a preset reference position, and output a signal indicative of the actual rotational angle θc of the motor 6 to the controller 1.

The motor-current sensing circuit 14 is operative to, for example, continuously measure a value of the drive current to be supplied to the armature of the motor 6, and output a signal indicative of the value of the drive current to the controller 1.

Note that the assist torque to be created by the motor 6 is represented as a function of a variable of the drive current to be supplied to the motor 6 from the controller 1. Thus, the controller 1 is designed to adjust the drive current to be supplied to the motor 6 based on the signals inputted thereto from the sensors 4, 12, 13, and 14 to thereby adjust the assist torque.

For example, the controller 1 is made up of, for example, a normal microcomputer; this microcomputer can consist of, for example, a CPU, at least one storage medium, an I/O device, and/or peripheral devices for the CPU.

Next, the functional structure of the controller 1 for adjusting the assist torque that assists the driver's turning effort of the steering wheel 2 will be described hereinafter. In the embodiment, as least part of the functional structure of the controller 1 is implemented by the microcomputer.

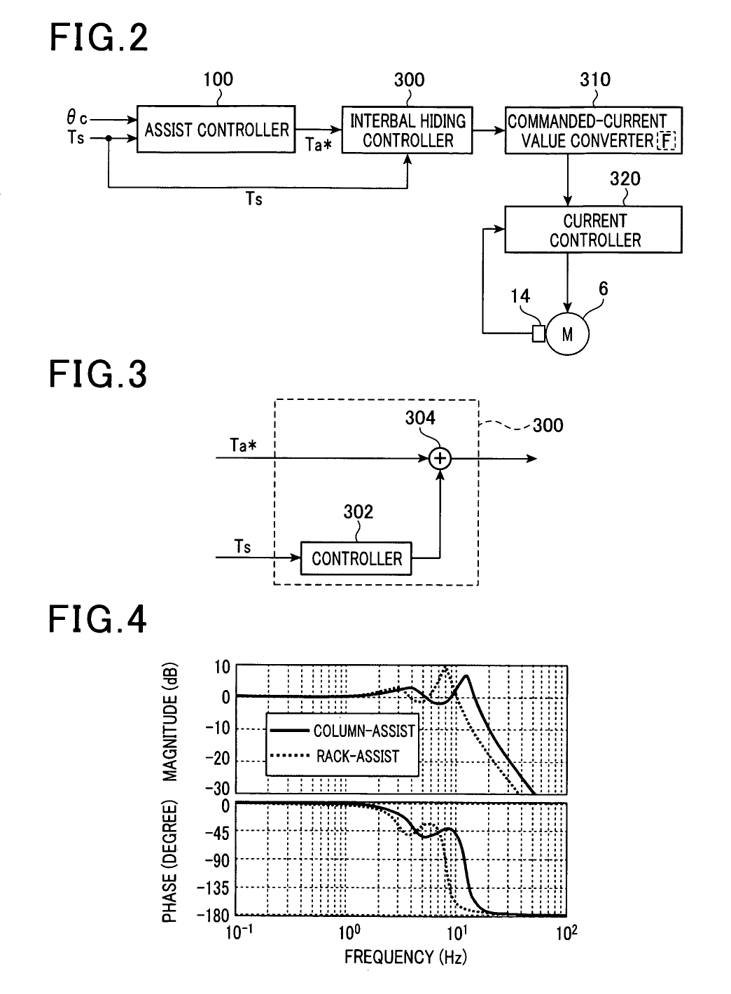

Referring to FIG. 2, the controller 1 is functionally equipped with an assist controller 100, a commanded-current value converter 310, a current controller 320, and an internal hiding controller (characteristic limiter) 300 interposed between the assist controller 100 and the commanded-current value converter 310. These functional blocks except for part of the current controller 320 can be implemented by one or more programs installed in the controller 1.

The assist controller 100 is designed to deter nine a commanded assist value Tα* as a commanded value for the assist torque to be generated by the motor 6. In the embodiment, referring to FIG. 2, the assist controller 100 is designed to determine the commanded assist value Tα* based on the torsion torque Ts and the rotational angle θc of the motor 5.

The internal hiding controller 300 is designed to limit each the system characteristics of the electric power steering system EPS functionally downstream of the commanded-current value converter 310 to a preset characteristic range, thus, for example, reducing fluctuations of each the system characteristics. Therefore, the internal hiding controller 300 is designed in accordance with the system characteristics functionally downstream of the commanded-current value controller 310.

Here, a system functionally downstream of the commanded-current value converter 310 includes: a steering mechanism including, for example, the motor 6 and the decelerating mechanism 5; sensors and the like associated with the steering mechanism, such as the motor-current sensing circuit 14, the torque sensor 4, and the like; and the current controller 320.

To the internal hiding controller 300, the torsion torque Ts and the commanded assist value Tα* are inputted. As described above, the internal hiding controller 300 is designed to limit the system characteristics of the electric power steering system EPS functionally downstream of the commanded-current value converter 310 to respective preset characteristic ranges. For this reason, the commanded assist value Tα* is determined as a commanded value for the assist torque to the system characteristics established by the internal hiding controller 300.

Thus, the internal hiding controller 300 is designed to determine a corrected commanded assist value by correcting the commanded assist value Tα* according to the system characteristics functionally downstream of the commanded-current value converter 310, and to input the corrected commanded assist value to the commanded-current value converter 310.

The commanded-current value converter 310 previously stores therein a data file F as a map or at least one relational expression. The data file F represents the assist torque as the function of the drive current to be supplied to the motor 6. In other words, the data file F represents a relationship between a variable of the assist torque and that of the drive current to be supplied to the motor 6.

When the corrected commanded assist value is inputted thereto, the commanded-current value converter 310 converts, based on the data file F, the corrected commanded assist value to a commanded current value corresponding thereto on the function.

The current controller 320 is provided with a motor driver. The motor driver is made up of, for example, an available bridge circuit consisting of, for example, four power transistors, such as four MOSFETs.

The motor driver is designed to change, based on a DC voltage applied thereto, the drive current to be applied to the motor 6 under control of the current controller 320. For example, when the motor driver is made up of an H bridge circuit consisting of four MOSFETs, the current controller 320 controls the on and off timings, that is, duty cycle, of each of the MOSFETs so as to change a voltage to be applied to the motor 6, thus changing the drive current to be applied to the motor 6.

Specifically, the current controller 320 is designed to carry out feedback control of the motor driver to thereby match a value of the drive current measured by the motor-current sensing circuit 14 with the corrected commanded current value to be supplied from the commanded-current value converter 310. The feedback control requires at least one control constant for determining the performance of the feedback control. For example, when carrying out MD control (Proportional-Integral-Derivative control) as the feedback control, a proportional constant, an integral constant, and a derivative constant can be required to be adjustable for determining the performance of the PID control.

Note that, in the embodiment, the motor-current sensing circuit 14 is provided with a current sensing resistor provided between an output terminal of the motor driver and a ground line thereof, and the motor-current sensing circuit 14 is designed to measure a voltage across the current sensing resistor to thereby measure the drive current flowing through the armature of the motor 6.

Next, the internal hiding controller 300 will be described in detail hereinafter, FIG. 3 schematically illustrates an example of the specific structure of the internal hiding controller 300.

Referring to FIG. 3, the internal hiding controller 300 is made up of a controller 302 and an adder 304.

To the controller 302, the torsion torque Ts is inputted. The controller 302 is operative to calculate, based on the torsion torque Ts, a compensation value for the commanded assist value Tα*. The adder 304 is operative to add the compensation value to the commanded assist value Tα* to thereby calculate the corrected commanded assist torque.

As described above, the internal hiding controller 300 is designed to limit the system characteristics of the electric power steering system EPS functionally downstream of the commanded-current value converter 310 to preset characteristic ranges, respectively. Thus, the characteristics of the system, referred to as real system, functionally downstream of the internal hiding controller 300 and the system characteristics established by the internal hiding controller 300 will be described.

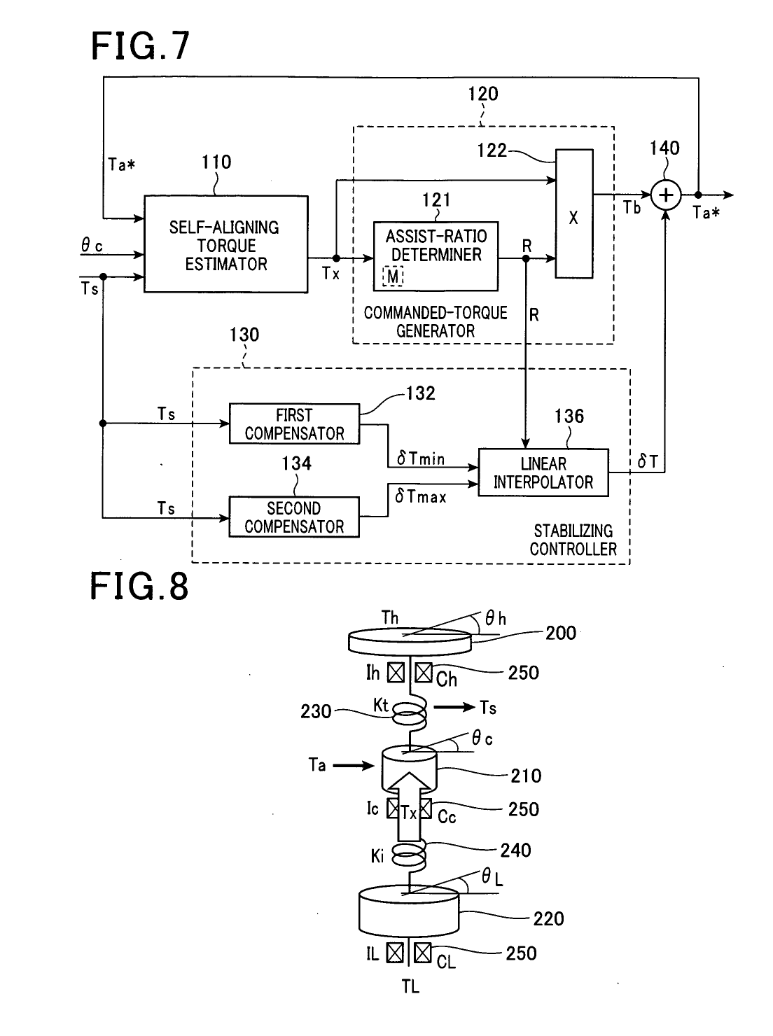

FIG. 4 illustrates a Bode diagram of the characteristics of the rent system when torque inputted by the driver's turning of the steering wheel 2 is inputted to the real system so that the torsion torque Ts is outputted therefrom.

Specifically, in FIG. 4, the amplitude ratio (gain) and the phase shift of the real system is plotted against frequency. Note that solid lines represent the characteristics of the real system of the column-assist electric power system EPS. Dashed lines represent the characteristics of the real system of a rack-assist electric power system for assisting the straight-line motion of the rack in place of assisting the driver's turning effort of the steering wheel 2.

Referring to FIG. 4, the characteristics of the real system of the column-assist electric power system EPS and those of the real system of the rack-assist electric power system are relatively-greatly different from each other.

In addition, each of the plotted gain curve of the characteristics of the column-assist electric power system EPS and that of characteristics of the rack-assist electric power system fluctuates to have a locally peak at the frequency of 10 Hz or therearound; this peak is higher than 0 dB.

Similarly, each of the plotted phase curve of the characteristics of the column-assist electric power system EPS and that of characteristics of the rack-assist electric power system fluctuates to have a locally peak at the frequency of 10 Hz or therearound.

FIG. 5 illustrates a Bode diagram of the characteristics of the real system in which the internal hiding controller 300 is provided when torque inputted by the driver's turning of the steering wheel 2 is inputted to the real system so that the torsion torque Ts is outputted therefrom.

Specifically, in FIG. 5, the amplitude ratio (gain) and the phase shift of the real system is plotted against frequency. Like FIG. 4, solid lines represent the characteristics of the real system of the column-assist electric power system EPS. Dashed lines represent the characteristics of the real system of a rack-assist electric power system for assisting the straight-line motion of the rack in place of assisting the driver's turning effort of the steering wheel 2.

Referring to FIG. 5, the internal hiding controller 300 allows the plotted characteristic curves (the gain curve and the phase curve) of the real system of the column-assist electric power system EPS to be substantially matched with the plotted characteristic curves (the gain curve and the phase curve) of the real system of the rack-assist electric power system.

In addition, each of the plotted characteristic curves (the gain curve and the phase curve) of the real system of the column-assist electric power system EPS is limited to be monotonically decreased at the frequency of 10 Hz or thereabout without fluctuating and the gain of the plotted gain curve at the frequency of 10 Hz is limited to be equal to or lower than 0 dB.

Similarly, each of the plotted characteristic curves (the gain curve and the phase curve) of the real system of the rack-assist electric power system is limited to be monotonically decreased at the frequency of 10 Hz or thereabout without fluctuating and the gain of the plotted gain curve at the frequency of 10 Hz is limited to be equal to or lower than 0 dB.

Specifically, the controller 302 establishes the system characteristics of the internal hiding controller 300 such that each of the gain and phase characteristic curves of the system is limited to monotonically decrease at the frequency of 10 Hz or therearound and the gain at the frequency of 10 Hz is limited to be equal to or lower than 0 dB.

Because the resonance frequency of mechanical mechanisms of electrical power steering systems is usually 10 Hz or thereabout, the established system characteristics of the internal hiding controller 300 restrict resonances.

In order to establish the system characteristics of the internal hiding controller 300 so as to restrict resonances set forth above, required specifications for open-loop frequency response of the controller 302 are established to the gain margin of 15 dB or over and the phase margin of 50 degrees or over. Note that the required specifications correspond to previously established reference values. The controller 302 is designed in accordance with the required specifications and a dynamic system; this dynamic system is obtained by modeling the real system between the corrected commanded assist value and the driving current supplied to flow through the motor 6.

FIG. 6 illustrates a Bode diagram of the open-loop frequency response of the controller 302 designed set forth above. Specifically, in FIG. 6, the amplitude ratio (gain) and the phase shift of the controller 302 in the column-assist electric power system EPS whose characteristics are illustrated in FIG. 4 are plotted against frequency by solid lines. In addition, in FIG. 6, the amplitude ratio (gain) and the phase shift of the controller 302 in the rack-assist electric power system whose characteristics are illustrated in FIG. 4 are plotted against frequency by dashed lines.

As illustrated in FIG. 6, the open-loop frequency response of the controller 302 in the column-assist electric power system EPS has the gain margin of 17 dB and the phase margin of 90 degrees. In addition, the open-loop frequency response of the controller 302 in the rack-assist electric power system has the gain margin of 32 dB and the phase margin of 90 degrees.

Thus, each of the controllers 302 in the column-assist electric power system EPS and in the rack-assist electric power system meets the required specifications. Using the controller 302 having the open-loop frequency response illustrated in FIG. 6 in the electric power system EPS allows the characteristics of the real system established by the internal hiding controller 300 to be limited to the characteristics illustrated in FIG. 5.

In other words, the internal hiding controller 300 forcibly limits the characteristics of the real system to those illustrated in FIG. 5 even if the real system is subjected to changes, such as changes of control parameters in the real system and changes in some of components (motor 6, gears, and grease) of the mechanical mechanism of the real system. This forcible limit equivalently hides the individual characteristics of the control parameters and the individual characteristics of some of the components of the mechanical mechanism, and establishes, as the characteristics of the real system, the characteristics illustrated in FIG. 5.

Note that the gain curve of the real system of the column-assist electric power system. EPS illustrated by solid lines in FIG. 5 is shifted in phase from the gain curve of the real system of the rack-assist electric power system illustrated by dashed lines in FIG. 5, respectively. This phase shift may be relatively large at a high-frequency range. The system characteristics of the real system established by the internal hiding controller 300 allow the phase shift.

The reason for allowing the phase shift is as follows.

As described above, the internal hiding controller 300 is operative to limit each of the characteristics of the system functionally downstream of the commanded-current value converter 310, in other words, each of the characteristics of the system without including the assist controller 100, to a preset characteristic range; this preset characteristic range is, for example, set to a corresponding one of the gain characteristic curve and the phase characteristic curve illustrated in FIG. 5. For this reason, the internal hiding controller 300 is designed on condition that no assist is applied to the driver's turning effort.

In contrast, because the high-frequency range means a state where the driver's turning effort of the steering wheel 2 is assisted by the motor 6 at a high level, it may be relatively difficult to limit each of the characteristics of the system functionally downstream of the commanded-current value converter 310 at the high-frequency range to a preset characteristic range.

However, because the assist controller 100 is designed to determine the assist torque when the driver's turning effort of the steering wheel 2 is assisted by the motor 6, the assist controller 100 can be relatively easily designed to meet the phase shift at the high frequency range. Thus, the system characteristics of the real system established by the internal hiding controller 300 allow the phase shift. This acceptance makes it possible to easily design the internal hiding controller 300.

Specifically, the controller 302 converts the torsion torque Ts inputted thereto into corrected torsion torque whose characteristics are illustrated in FIG. 6. The commanded assist value Tα* and the converted torsion torque Ts are added by the adder 304 so that the commanded assist value Tα* is converted into the corrected commanded assist value whose characteristics are illustrated in FIG. 5. In other words, the internal hiding controller 300 establishes the characteristics of the real system provided with the internal hiding controller 300 are illustrated in FIG. 5.

Next, an example of the specific structure of the assist controller 100 will be described hereinafter.

The assist controller 100 is configured to determine the commanded assist value Tα* for the system characteristics determined by the internal hiding controller 300 as illustrated in FIG. 5. That is, because the system characteristics of the real system provided with the internal hiding controller 300 are limited to restrict resonances, the assist controller 100 can be designed in little consideration of restricting resonances.

FIG. 7 schematically illustrates an example of the specific structure of the assist controller 100.

Referring to FIG. 7, the assist controller 100 is functionally equipped with a self-aligning torque estimator 110, a commanded-torque generator 120, and a stabilizing controller 130. These functional blocks can be implemented by one or more programs installed in the assist controller 100.

The commanded assist value Tα* is the sum of a basic request assist value 71 and a compensation value δT. The commanded-torque generator 120 generates the basic request assist value 717 based on a self aligning torque Tx estimated by the self-aligning torque estimator 110.

The self aligning torque Tx is the torque (force) that causes each wheel 11 (the tire of each wheel 11) to tend to rotate it around its vertical axis. For example, when there is a slip angle of the tire of each wheel 11, the self aligning torque created by each wheel 11 causes the tire of a corresponding one of the wheels 11 to tend to rotate around its vertical axis.

For example, the self aligning torque Tx includes torque due to the road reaction force caused when the driver turns the steering wheel 2, and/or torque due to the rotation of each wheel 11 (the tire of each wheel 11) caused when there are irregularities on the contact patch.

First, operations of the self-aligning torque estimator 110 will be described hereinafter.

The self-aligning torque estimator 110 is designed as a disturbance observer to receive the torsion torque Ts, the rotational angle θc of the motor 6, and the commanded assist value Tα*; these parameters axe inputted to the controller 1. The self-aligning torque estimator 110 is designed to estimate, based on the torsion torque Ts, the rotational angle θc of the motor 6, and the commanded assist value Tα*, an estimated value of the self aligning torque Tx in accordance with the following equation [1]:

$$\tilde{T} x = \frac{1}{τ s + 1} ( Ta + Ts ) - \frac{s}{τ s + 1} θ {c}^{′} Ic - \frac{1}{τ s + 1} Cc θ {c}^{′} \qquad [ 1 ]$$

where \tilde{T}x represents an estimated value of the self aligning torque, τ represents a cutoff frequency, and s represents Laplace operator (differential operator).

Note that the cutoff frequency τ in the equation [1] is determined to a frequency that separates: the first frequency range of the first components of the self aligning torque rx due to the road reaction force caused when the driver turns the steering wheel 2; and the second frequency range of the second components of the self aligning torque Tx due to the transfer of the conditions of the road surface to the front wheels 11 (the tires of the front wheels 11). For example, the second components of the self aligning torque is caused when there are irregularities on the contact patch due to the road surface.

Specifically, the cutoff frequency τ is set to 5 Hz that eliminates the second components of the self aligning torque Tx.

For this reason, the self aligning torque Tx is mainly due to the road reaction force caused when the driver turns the steering wheel 2.

The equation [1] is derived from a model M of the electronic power steering system EPS illustrated in FIG. 1; this model M is illustrated in FIG. 8 as an example.

Next, the model M of the electric power steering system EPS will be described hereinafter with reference to FIG. 8.

The model M illustrated in FIG. 8 comprises a steering-wheel portion 200, a motor portion 210, and a pinion-rack portion 220. The steering-wheel portion 200 is coupled to one end of a spring 230 with a torsion spring coefficient Kt corresponding to the torsion bar 4a, and the motor portion 210 is coupled to the other end of the spring 230. The motor portion 210 is coupled to one end of a spring 240 with a torsion spring coefficient Ki corresponding to the intermediate shaft 7, and the pinion-rack portion 220 is coupled to the other end of the spring 240. Reference numeral 250 represents a frictional resistance caused when a corresponding one of portions 200, 210, and 220 is turned.

In FIG. 8, reference character Th represents torque inputted by the driver's turning of the steering-wheel portion 200, reference character Tα represents the assist torque created by the motor portion 210, and reference character Ts represents the torsion torque set forth above. The torque Th will be referred to as “inputted torque” hereinafter.

Reference character θh represents a displacement (rotation) angle of the steering-wheel portion 200, reference character θc represents a displacement angle of the output shaft of the motor portion 210, and reference character θ_{L} represents a displacement angle of the pinion-rack portion 220.

In FIG. 8, reference character Ih represents a moment of inertia of the steering-wheel portion 200, reference character Ic represents a moment of inertia of the output shaft of the motor portion 210, and reference character I_{L} represents a moment of inertia of the pinion-rack portion 220. Reference character Ch represents a rotational friction coefficient of the steering-wheel portion 200, reference character Cc represents a rotational friction coefficient of the motor portion 210, and reference character C_{L} represents a rotational friction coefficient of the pinion-rack portion 220.

From the model M illustrated in FIG. 3, the following equation [2] as the equation of the rotary motion of the steering-wheel portion 200 is established:

Ihθh″=Th−Chθh′−Kt(θh−θc) [2]

where θh″ represents the angular acceleration of the steering-wheel portion 200 corresponding to the second order differential of the displacement angle θh of the steering-wheel portion 200. Here, the friction based on the rotational friction coefficient Ch of the steering-wheel portion 200 produces torque proportional to the rate of change in the displacement angle θh of the steering-wheel portion 200; this torque is opposite in direction to the inputted torque Th. Thus, −Chθh′ represents the torque produced by the rotational friction coefficient Ch.

In addition, in the equation [2], the spring 230 produces torque proportional to the relative displacement angle (θh−θc) of the spring 230 (torsion bar 4a); this torque is opposite in direction to the inputted torque Th. Thus, −Kt(θh−θc) represents the torque produced by the spring 230 (torsion bar 4a).

Similarly, from the model M illustrated in FIG. 8, the following equation [3] as the equation of the rotary motion of the output shaft of the motor portion 210 is established:

Icθc″=Tα+Kt(θh−θc)−Ccθc′−Ki(θc−θ_{L}) [3]

where θc″ represents the angular acceleration of the output shaft of the motor portion 210 corresponding to the second order differential of the displacement angle θc of the output shaft of the motor portion 210. Here, Kt(θh−θc) represents torque applied to the spring 230 (torsion bar) Tα. The friction based on the rotational friction coefficient Cc of the motor portion 210 produces torque proportional to the rate of change in the displacement angle θc of the output shaft of the motor portion 210; this torque is opposite in direction to the assist torque Tα. Thus, −Ccθc′ represents the torque produced by the rotational friction coefficient Cc.

In addition, in the equation [3], the spring 240 produces torque proportional to the relative displacement angle (θc−θ_{L}) of the spring 240 (intermediate shaft 7; this torque is opposite in direction to the assist torque Tα. Thus, −Ki(θc−θ_{L}) represents the torque produced by the spring 240 (intermediate shaft 7).

In addition, from the model M illustrated in FIG. 3, the following equation [4] as the equation of the rotary motion of the pinion-rack portion 220 is established:

I_{L}θ_{L}″=Ki(θc−θ_{L})−C_{L}θ_{L}θ−T_{L} [4]

where θ_{L}″ represents the angular acceleration of the pinion-rack portion 220 corresponding to the second order differential of the displacement angle θ_{L} of the pinion-rack portion 220. Here, Ki(θc−θ_{L}) represents torque, referred to as “intermediate torque”, applied to the spring 240 (intermediate shaft 7). The friction based on the rotational friction coefficient C_{L} of the pinion-rack portion 220 produces torque proportional to the rate of change in the displacement angle θ_{L} of the pinion-rack portion 220; this torque is opposite in direction to the intermediate torque. Thus, −C_{L}θ_{L}′ represents the torque produced by the rotational friction coefficient C_{L}. Reference character T_{L} is the torque applied to the tires of the front wheels 11 based on reaction force from the corresponding road surface against the inputted torque Th and the assist torque Tα.

In the model M illustrated in FIG. 8, the torque transferred from the tires (front wheels 11) to the torsion bar 4a, in other words, the self aligning torque Tx, is obtained by the torque applied to the spring 240 representing the intermediate shaft 7. Thus, the self aligning torque Tx is represented by the following equation [5]:

Tx=Ki(θc−θ_{L}) [5]

Using the equation [3] allows the equation [5] to be deformed into the following equation [6]:

Tx=Tα+Kt(θh−θc)−Icθc″−Ccθc′ [6]

The second term on the right side of the equation [6] represents the torsion torque Ts. Thus, because the moment of inertia of each of the steering-wheel portion 200, the motor portion 210, and the pinion-rack portion 220 has been determined as designed values of the model M, the equation [6] shows that the assist torque Tα, the torsion torque Ts, and the angular acceleration of the output shaft of the motor portion 210 allow the self aligning torque Tx to be estimated.

In order to eliminate noise, when a low-pass filter represented as a transfer function of 1/(τs+1) is applied to the system defined by the equation [6], the following equation [7] is obtained:

$$\tilde{T} x = \frac{1}{τ s + 1} ( Ta + Ts - Ic θ {c}^{″} - Cc θ {c}^{′} ) \qquad [ 7 ]$$

Deformation of the equation [7] allows the equation [1] set forth above to be obtained.

Returning to FIG. 7, the self aligning torque Tx estimated by the self-aligning torque estimator 110 is inputted to the commanded-torque generator 120. The commanded-torque generator 120 functionally includes an assist-ratio determiner 121 and a multiplier 122.

The assist-ratio determiner 121 serves as a module that determines the ratio of the motor's share of torque for compensating the self aligning torque Tx within a range from 0 to 1; this ratio will be referred to as “assist ratio R”. For example, the assist-ratio determiner 121 stores therein an assist-ratio determining map MA designed as, for example, a data table or a program. The assist-ratio determining map MA represents a function (relationship) between a variable of the self aligning torque Tx and a variable of the assist ratio R. The function can have been determined based on data obtained by tests using the electric power steering system EPS illustrated in FIG. 1 or its equivalent computer model.

For example, the assist-ratio determining map MA has been determined such that the assist ratio R is proportional to the self aligning torque Tx. Specifically, when the self aligning torque Tx takes a value within a first lower range, the assist torque R takes a value within a second lower range corresponding to the first lower range. In addition, when the self aligning torque Tx takes a value within a first higher range, the assist torque R takes a value within a second higher range corresponding to the first higher range.

Preferably, the assist-ratio determining map MA has been determined such that the assist ratio R is proportional to the self aligning torque Tx until the self aligning torque Tx is within a preset range, and is constant when the self aligning torque Tx exceeds the preset range.

The assist-ratio determining map MA determined set forth above allows, when the self aligning torque Tx is within a lower range during the motor vehicle running at high speed, the assist ratio R to be set within a lower range corresponding to the lower range of the self aligning torque Tx. This set restricts small circumferential vibrations of the steering wheel 2, and gives the driver suitable reaction torque when turning the steering wheel 2.

In addition, the assist-ratio determining map MA, determined set forth above allows, when the self aligning torque Tx is within a higher range during the motor vehicle running at low speed, such as, the driver doing the parking, the assist ratio R to be set within a higher range corresponding to the higher range of the self aligning torque Tx. This set allows the driver to turn the steering wheel easily (lightly) with an aid of the motor 6.

The multiplier 122 is designed to multiply the self aligning torque Tx estimated by the estimator 110 by the assist ratio R determined by the assist-ratio determiner 121 to thereby achieve a value as the basic request assist value Tb. The multiplier 122 is designed to output, to the adder 140, the basic request assist value Tb.

The adder 140 is designed to add the basic request assist value Tb to a compensation value δT determined by the stabilizing controller 130 to thereby calculate the commanded assist value Tα*.

Next, the stabilizing controller 130 will be described hereinafter.

The stabilizing controller 130 is designed such that its characteristics vary depending on the assist ratio R. Specifically, the stabilizing controller 130 is designed to determine the compensation value δT on the basis of the characteristics defined by a value of the assist ratio R from the torsion torque Ts as an input for the defined characteristics.

The reason why the stabilizing controller 130 is designed such that its characteristics vary depending on the assist ratio R is as follows:

Specifically, the change in the assist ratio R changes a resonance characteristic of a control system designed to output the torsion torque Ts from an input of the inputted torque Th by the driver's turning of the steering wheel 2.

The stabilizing controller 130 functionally includes a first compensator 132, a second compensator 134, and a linear interpolator 136.

The first compensator 132 has a transfer function Gmin(z) for stabilizing the control system illustrated in FIG. 2 assuming that the assist ratio R is zero as a preset minimum value.

Specifically, the first compensator 132 is designed to calculate a first compensation value (minimum limit) δTmin each time the torsion torque Ts is inputted thereto in accordance with the following equation [8]:

∂Tmin=Gmin(z)·Ts [8]

The second compensator 134 has a transfer function Gmax(z) for stabilizing the control system illustrated in FIG. 2 assuming that the assist ratio R is a maximum value Rmax. Note that the maximum value has been determined by tests using the electric power steering system EPS illustrated in FIG. 1 or its equivalent computer model.

Specifically, the second compensator 134 is designed to calculate a second compensation value (maximum limit) δTmax each time the torsion torque Ts is inputted thereto in accordance with the following equation [9]:

∂Tmax=Gmax(z)·Ts [9]

To the linear interpolator 136, the assist ratio R, the first compensation value δTmin, and the second compensation value δTmax are inputted. The linear interpolator 126 is designed to linearly interpolate the first and second compensation values δTmin and δTmax based on the assist ratio R to thereby determine the compensation value δT depending on the assist ratio R. Specifically, the linear interpolator 136 is designed to determine the compensation value δT in accordance with the following equations [10a to 10e]:

$$\begin{matrix}\frac{δ T - δ T min}{δ T max - δ T min} = \frac{R - 0}{R max - 0} & [ 10 a ] \\ δ T - δ T min = \frac{R}{R max} ( δ T max - δ T min ) & [ 10 b ] \\ δ T = \frac{R}{R max} ( δ T max - δ T min ) + δ T min & [ 10 c ] \\ δ T = \frac{R}{R max} δ T max - \frac{R}{R max} δ T min + \frac{R max}{R max} δ T min & [ 10 d ] \\ δ T = \frac{R max - R}{R max} δ T min + \frac{R}{R max} δ T max & [ 10 e ]\end{matrix}$$

Then, as described above, the compensation value δT determined by the stabilizing controller 130 is added to the basic request assist value Tb so that the sum of the compensation value δT and the basic request assist value Tb is supplied, as the commanded assist value Tα*, to the internal hiding controller 300.

Thereafter, as described above, the corrected commanded assist value is determined by the internal hiding controller 300 based on the commanded assist value Tα* and the torsion torque Ts.

The corrected commanded assist value is converted by the commanded-current value converter 310 to a commanded current value corresponding thereto on the function stored in the commanded-current value converter 310. The current controller 320 performs feedback control of the motor driver to thereby match a value of the drive current measured by the motor-current sensing circuit 14 with the corrected commanded current value to be supplied from the commanded-current value converter 310.

Thus, the adjustment of the assist torque using, as the commanded assist value Tα*, the sum of the basis request assist value Tb and the compensation value δT gives the driver comfortable steering feeling.

As described above, the electric power steering system EPS according to the embodiment is provided with the internal hiding controller (characteristic limiter) 300 interposed between the assist controller 100 and the commanded-current value converter 310. The internal hiding controller 300 is configured to limit each of the system characteristics of the electric power steering system EPS functionally downstream of the commanded-current value converter 310 to a preset characteristic range.

This configuration allows the assist controller 100 to be designed on condition that the system characteristics of the electric power steering system EPS functionally downstream of the commanded-current value converter 310 is limited to a preset characteristic range. Thus, it is possible to easily design the assist controller 100 in comparison to conventional electric power steering systems.

In addition, the internal hiding controller 300 is designed in consideration of the system characteristics of the electric power steering system EPS downstream of the commanded-current value converter 310, making it possible to easily design the internal hiding controller 300.

That is, although at least one control parameter required for the current controller 320 to carry out the feedback control is changed or not, or at least part of the mechanical mechanism of the electric power steering system EPS, such as the motor 6, the gears, and/or grease, is changed or not, each of the characteristics of the electric power steering system EPS downstream of the commanded-current value converter 310 is limited to a preset change range. This makes it unnecessary to adjust parameters (control constants) of the electric power steering system EPS upstream of the internal hiding controller 300, thus facilitating the design of the electric power steering system EPS so as to reduce the number of human-hours required to design the system EPS even if at least one of the control constants in the system EPS downstream of the commanded-current value converter 310 is changed.

In the embodiment, the assist controller 100 is designed to determine the commanded assist value Tα* based on the self-aligning torque Tx, but the present invention can be designed to apply at least one of the inertial compensation, the damping control, and the steering-wheel returning control for the basic assist torque Tb so as to determine the corrected commanded assist value.

For example, the inertia compensation is designed to correct the basis assist torque Tb so as to compensate a change in the commanded assist value Tα* due to the inertia of the motor 6 and the like. The damping control is designed to correct the basic assist torque Tb so as to compensate fluctuations in the steering wheel 2. The steering-wheel returning control is designed to correct the basic assist torque Tb so as to increase the driver's steering feeling when the driver returns the steering wheel 2.

The current controller 320 can carry out the inertial compensation, the damping control, and/or the steering-wheel returning control so as to further correct the corrected commanded-current value. In this modification, the present invention can reduce the number of human-hours required to design the system EPS even if at least one of the control constants in the system EPS downstream of the commanded-current value converter 310 is changed.

In the embodiment, the internal hiding controller 300 determines the corrected commanded assist value based on the commanded assist value Tα* and the torsion torque Ts, but can determine it based on, in addition to the commanded assist value Tα* and the torsion torque Ts, the drive current to be applied to the motor 6 and/or a rotational speed of the motor 6.

In the embodiment, the electric power steering system EPS is designed as a column-assist (shaft-assist) electric power steering system, but the present invention is not limited to the application. Specifically, the present invention can be applied to other assist-types of electric power steering system, such as rack-assist electric power steering systems for assisting the straight-line motion of the rack.

While there has been described what is at present considered to be the embodiment and its modifications of the present invention, it will be understood that various modifications which are not described yet may be made therein, and it is intended to cover in the appended claims all such modifications as fall within the scope of the invention.

What is claimed is:

1. An electric power steering system installed in a vehicle and operative to generate, by a steering mechanism including a motor, assist torque for assisting turning effort of the steering wheel by a driver, the electric power steering system comprising:
a, commanded-value generator that generates a first commanded value for the assist torque;
a converter that converts a second commanded value for the assist torque to a commanded current value;
a current controller that controls a drive current for driving the motor so as to cause the motor to generate a value of the assist torque, the value of the assist torque corresponding to the commanded current value; and
a characteristic limiter that is functionally interposed between the commanded-value generator and the converter and that limits, to a preset characteristic range, a characteristic of a functional downstream of the converter in the electric power steering system, the functional downstream of the converter in the electric power steering system including the steering mechanism,
the commanded-value generator being configured to input, to the characteristic limiter, the first commanded value for the assist torque generated thereby, the characteristic limiter being configured to determine the second commanded current value for the assist torque based on the characteristic of the functional downstream of the converter in the electric power steering system and the first commanded value for the assist torque.

2. The electric power steering system according to claim 1, wherein the vehicle comprises a torsion bar that couples an input shaft and a wheel-side output shaft, the input shaft being coupled to the steering wheel, further comprising a torque detector that detects torsion torque based on a twist of the torsion bar caused by a driver's turning of the steering wheel,
wherein the characteristic limiter is configured to:
determine, based on at least the first commanded value for the assist torque, the torsion torque detected by the toque detector, and the limited characteristic of the functional downstream of the converter in the electric power steering system, the second commanded value for the assist torque; and
input the second commanded value for the assist torque to the converter.

3. The electric power steering system according to claim 1, wherein the characteristic limiter is configured to limit the characteristic of the functional downstream of the converter in the electric power steering system to the preset characteristic range, the preset characteristic range restricting resonances.

4. The electric power steering system according to claim 3, wherein, when the characteristic of the functional downstream of the converter in the electric power steering system is represented as at least one of a gain curve and a phase curve plotted against frequency in a Bode diagram, the characteristic limiter is configured to limit such that the at least one of the gain curve and the phase curve is monotonically decreased at a frequency of 10 Hz, and the gain curve is equal to or lower than 0 dB.

5. The electric power steering system according to claim 4, wherein the characteristic limiter has an open-loop characteristic with a gain margin and a phase margin, the gain margin and the phase margin being equal to or higher than preset reference values, respectively, and the characteristic limiter is configured to limit the characteristic of the functional downstream of the converter in the electric power steering system to the preset characteristic range based on the open-loop characteristic.
